(19) United States
(12) Patent Application Publication
(10) Pub. No.: US 2014/0340573 A1
(43) Pub. Date: Nov. 20, 2014

(54) Light Emitting Mobile Device Case

(71) Applicant: Cassidy Clawson, Santa Criz, CA (US)

(72) Inventor: Cassidy Clawson, Santa Criz, CA (US)

(21) Appl. No.: 14/076,052

(22) Filed: Nov. 8, 2013

Related U.S. Application Data
(60) Provisional application No. 61/823,561, filed on May 15, 2013.

(51) Int. Cl. H04N 5/225

(52) U.S. Cl. CPC H04N 5/2256; H04N 5/2252
USPC 348/371

(57) ABSTRACT

The present disclosure provides a mobile device case comprising a flash detector and one or more light sources. The mobile device case can mount a mobile device. The flash detector can detect the illumination of a mobile device's flash, while at least a portion of the illumination from the mobile device's flash is blocked by other opaque components of the mobile device case. When the flash detector detects illumination of the mobile device's flash, the mobile device case can activate at least some of the light sources to replace the blocked illumination of the mobile device's flash with stronger illumination, diffused illumination, and/or illumination with a different color or color temperature than the light output by the mobile device's flash.

### CLAIM OF PRIORITY

This application claims priority under 35 U.S.C. §119(e) from earlier filed U.S. Provisional Application Ser. No. 61/823,561, filed May 15, 2013, by Cassidy Clawson, the entirety of which is incorporated herein by reference.

### BACKGROUND

1. Field of the Invention

The present disclosure relates to attachments for mobile devices, particularly mobile device attachments having one or more light sources for camera flashes or other illumination.

2. Background

Individuals enjoy capturing photos and videos with digital cameras that are incorporated into mobile devices such as mobile phones, personal digital assistants, and tablet computers. Cameras in mobile devices often capture images of good or acceptable quality in daylight or when scenes are sufficiently bright. However, images captured at night or in low-light environments are often of inferior quality due to the inherent limitations of small cameras, including reduced sensor size, small apertures, and weak on-camera flash devices. Low-light images from mobile devices tend to exhibit undesirable blur, grain, and color as the camera compensates for insufficient light with excessive sensor gain and long shutter speeds.

Many camera-equipped mobile devices include a combination strobe and video light, such as a light emitting diode (LED), to provide supplementary illumination to a scene while capturing photos or video. While these light sources improve the low-light performance of the camera, the light is often insufficiently bright to produce satisfactory images. Additionally, these light sources often emit light of low photographic quality, as characterized by inappropriate color temperature, low color rendering performance and excessive point-source harshness. For example, a typical mobile device flash results in low-light images that exhibit unappealing skin tones, unnatural color and harsh shadows.

### BRIEF DESCRIPTION OF THE DRAWINGS

FIG. 1 depicts an angled back view of an exemplary embodiment of a mobile device case.

FIG. 2 depicts an exploded view of an exemplary embodiment of a mobile device case.

FIG. 3 depicts an angled front view of an exemplary embodiment of a mobile device case.

FIG. 4 depicts a back view of an embodiment of a mobile device case with a diffuser removed.

FIG. 5A depicts a back view of the embodiment of FIG. 4 with a diffuser attached over light sources.

FIG. 5B depicts a top view of the embodiment of FIG. 4 with a diffuser attached over light sources.

FIG. 5C depicts a side view of the embodiment of FIG. 4 with a diffuser attached over light sources.

FIG. 5D depicts a bottom view of the embodiment of FIG. 4 with a diffuser attached over light sources.

FIG. 6 depicts an alternate embodiment of a mobile device case having a plurality of light sources arranged in rows and columns, and discrete diffusers over each light source.

FIG. 7 depicts an alternate embodiment of a mobile device case having a diffuser that partially extends across the back of the mobile device case.

FIG. 8 depicts an alternate embodiment of a mobile device case having a diffuser that extends substantially across the entirety of the back of the mobile device case.

FIG. 9 depicts a close up view of a partial cross section of an embodiment of the mobile device case having a plurality of flash detectors within light chambers.

FIG. 10 depicts a close up view of a partial cross section of an embodiment of the mobile device case having a single flash detector within a light chamber.

FIG. 11A depicts a graph of relative brightness levels of a spectrum of possible color temperature mixes between unaltered subsets of light sources.

FIG. 11B depicts a graph of relative brightness levels of a spectrum of possible color temperature mixes between one unaltered subset of light sources and another subset of light sources with color temperature warming material.

### DETAILED DESCRIPTION

In view of the various limitations associated with light sources, recognized herein is the need for a case for a mobile device that has one or more light sources that can be used to light a scene in lieu of, and/or more brightly than, the mobile device's regular flash. The case can have a diffuser to soften the light produced by the one or more light sources to create the soft light preferred by many photographers. In some embodiments, the one or more light sources can output light of a customized color and/or color temperature.

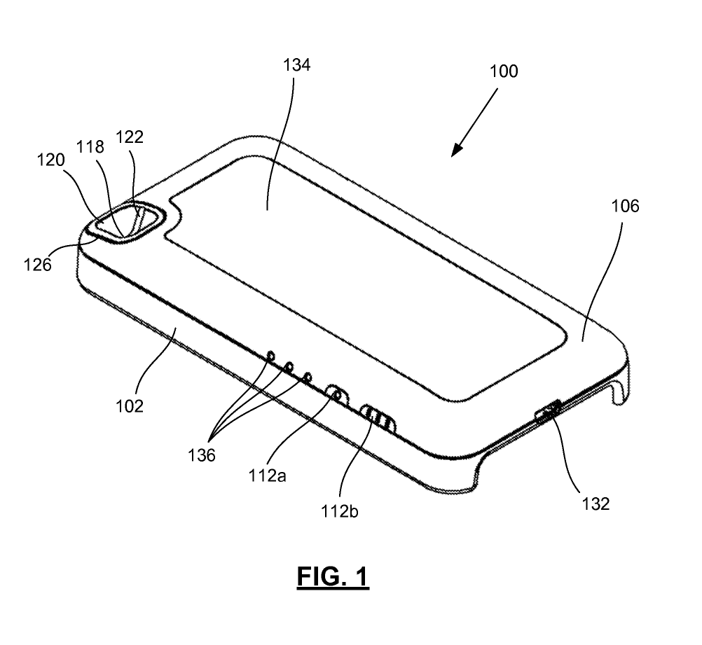

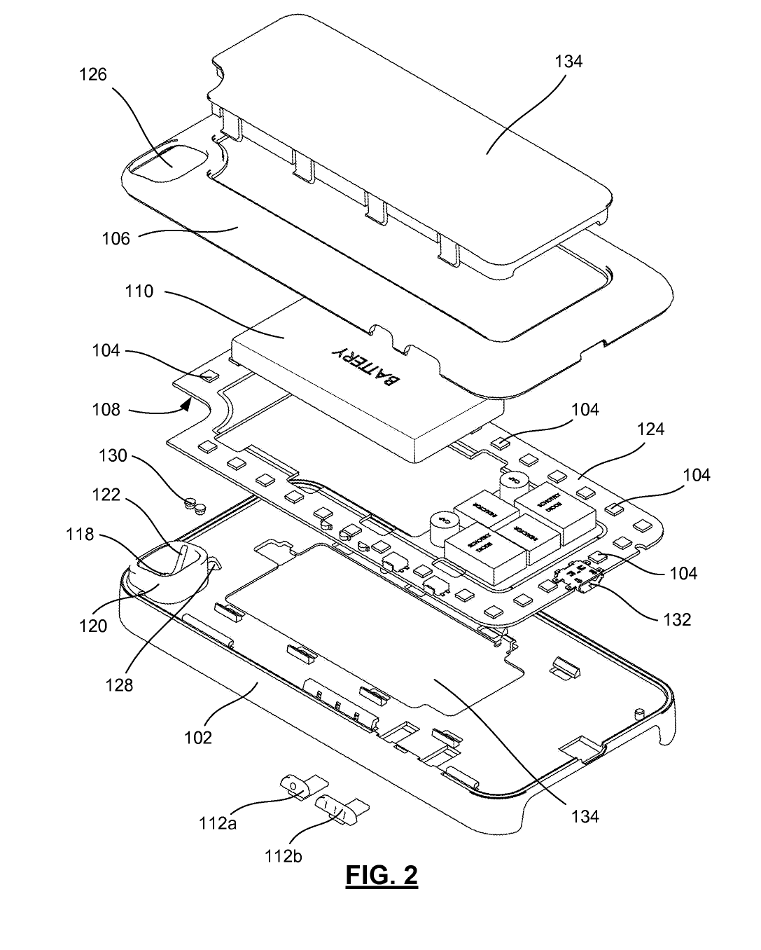

FIG. 1 depicts an angled back view of an exemplary embodiment of a mobile device case 100, and FIG. 2 depicts an exploded view of the exemplary embodiment of the mobile device case 100. The mobile device case 100 can comprise a housing 102, one or more light sources 104, one or more diffusers 106, at least one flash detector 108, one or more batteries 110, and/or one or more hardware controls 112. The one or more batteries 110 can be electrically coupled to the light sources 104 and/or other components of the mobile device case 100. The mobile device case 100 can be configured to be coupled with a mobile electronic device (also “mobile device” herein) comprising a camera sensor and a flash. By way of non-limiting examples, the mobile device can be a mobile phone such as an iPhone®, personal digital assistant, tablet computer, or any other type of mobile device with a camera sensor and flash.

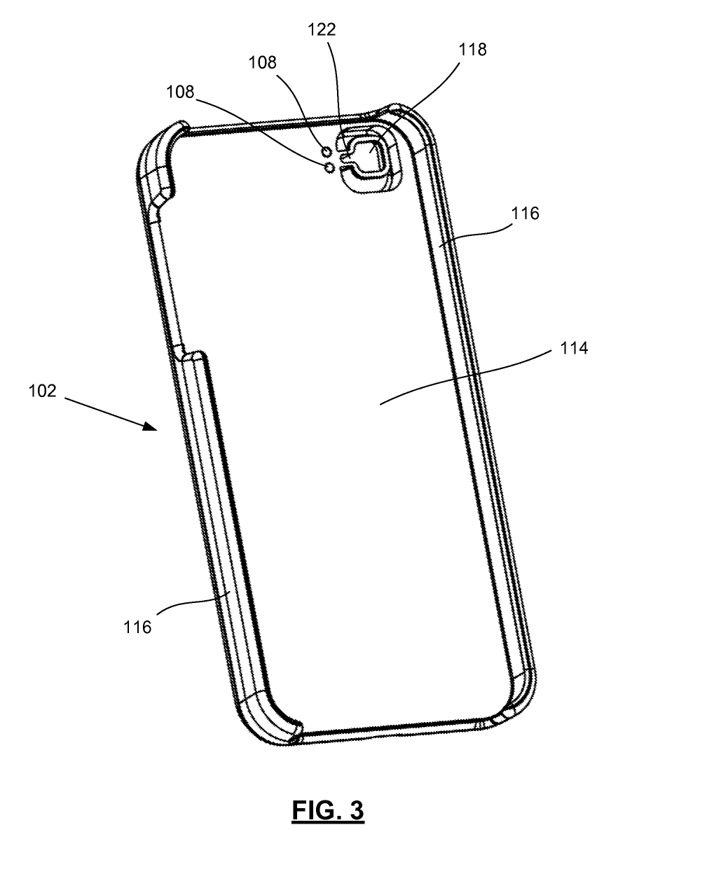

FIG. 3 depicts an angled front view of an exemplary embodiment of a mobile device case 100. The mobile device case 100 can comprise a housing 102. In some embodiments, the housing 102 can be shaped to at least partially receive and retain a mobile device. In alternate embodiments the housing 102 can be configured to be coupled with one or more sides of a mobile device, be held against a surface of a mobile device with a strap, clip or other retaining member, or be coupled with a mobile device in any other manner.

In some embodiments, the housing 102 can comprise a back wall 114 and one or more side walls 116. The side walls 116 can extend substantially perpendicularly away from the edges of the back wall 114. The back wall 114 can be substantially the same size and shape as the back of the mobile device. The side walls 116 can be positioned and shaped to at least partially extend along the side edges of the mobile device when the mobile device is housed within the mobile device case 100. In some embodiments, one or more side walls 116 can have a lip or prong that can latch onto the front of the mobile device to at least partially retain the mobile device within the mobile device case 100. One or more of the side walls 116 and/or back wall 114 can be shaped with indentations, openings, cut-outs, or other spaces configured to align with components of the mobile device, such as buttons, ports, headphone jacks, or other components, when the mobile device is retained by the mobile device case 100 so that the mobile device's components can be operated by a user despite the presence of the mobile device case 100. In alternate embodiments, the housing 102 can comprise or be coupled with a clip, strap, attachment, sleeve, or any other structure that is configured to retain the housing 102 against one or more surfaces of the mobile device.

The housing 102 can define one or more apertures 118. Each aperture 118 can be an opening positioned such that the aperture 118 can align with a particular component of the mobile device when the mobile device is retained by the mobile device case 100. By way of a non-limiting example, in some embodiments the back wall 114 can define an aperture 118 configured to align with the mobile device's camera sensor when the mobile device is positioned within and retained by the mobile device case 100, such that the camera sensor can remain uncovered by the mobile device case 100. In some embodiments, the housing 102 can further comprise an aperture frame 120 that extends from the back wall 114 and surrounds the aperture 118, as shown in FIG. 2.

In some embodiments, the aperture 118 and/or aperture frame 120 can be shaped to leave the mobile device's camera sensor uncovered, and to also leave a microphone of the mobile device uncovered. The aperture 118 and/or aperture frame 120 can have various cross-sectional shapes and sizes. In some examples, the aperture 118 and/or aperture frame 120 have cross-sectional shapes that are circular, triangular, square, rectangular, pentagonal, or hexagonal, or partial shapes thereof. By way of a non-limiting example, the aperture 118 as shown in FIGS. 2 and 3 is substantially square, but has a slot 122 extending from the square to leave a microphone next to the camera sensor on the mobile device uncovered.

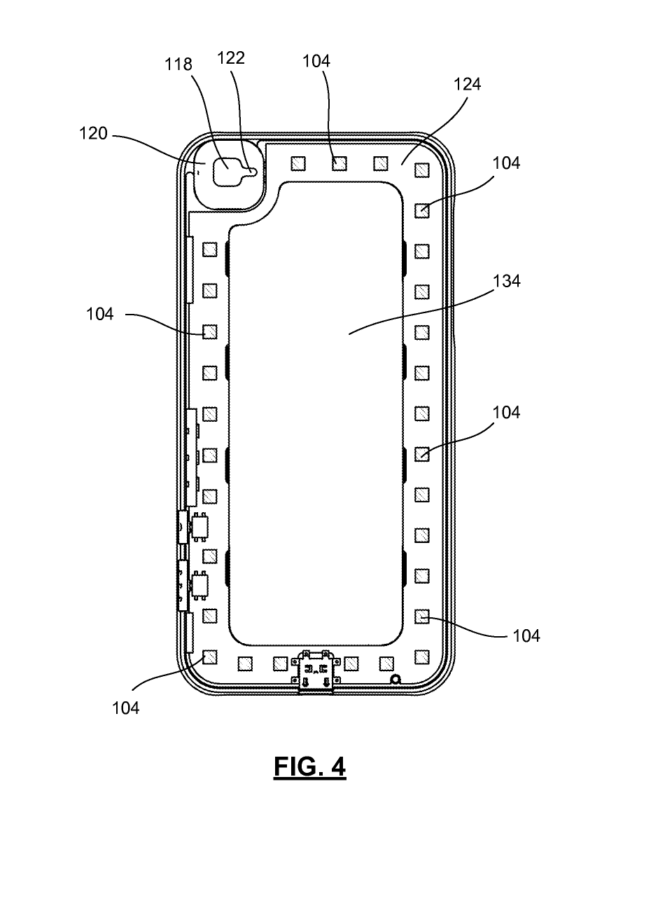

FIG. 4 depicts a back view of an exemplary embodiment of a mobile device case 100 with a diffuser 106 removed. The mobile device case 100 can comprise one or more light sources 104. At least some of the light sources 104 can be positioned on the outward-facing side of the back wall 114, opposite to the side of the back wall 114 that is configured to come into contact with the mobile device when the mobile device case 100 retains the mobile device. In some embodiments, as shown in FIGS. 2 and 4, the light sources 104 can be mounted on a printed circuit board (PCB) 124 coupled with the back wall 114, while in other embodiments the light sources 104 can be mounted directly on the housing 102.

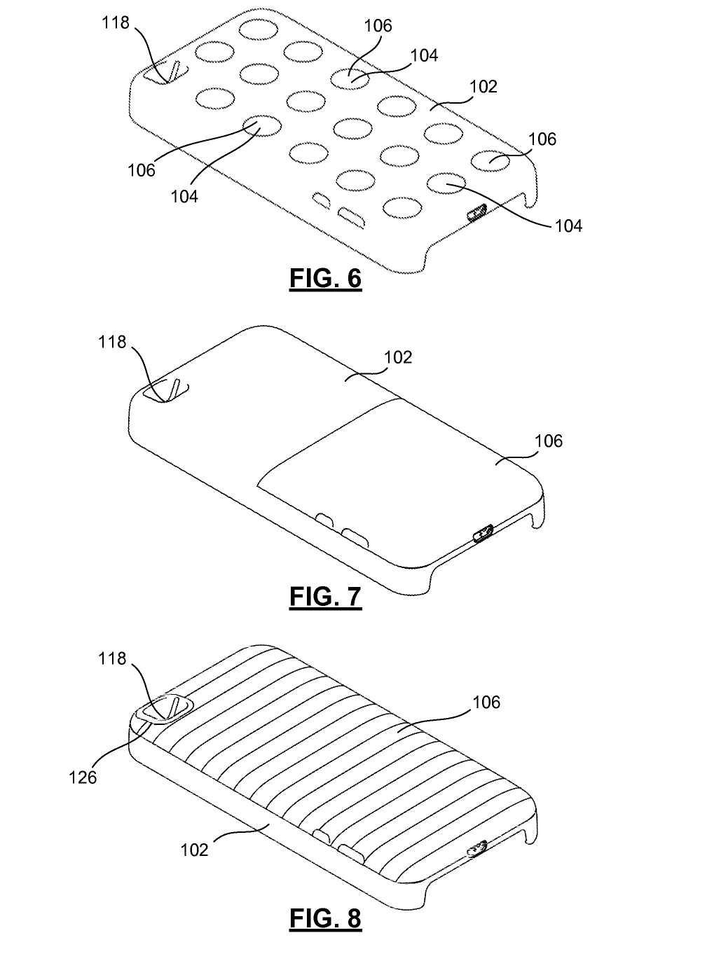

In some embodiments, one or more light sources 104 can be positioned in a ringed arrangement around the side edges of the back wall 114. The ringed arrangement can be substantially rectangular to follow the shape of the back wall 114 and/or edges of the mobile device. By way of a non-limiting example, FIG. 4 depicts an embodiment in which a plurality of light sources 104 is substantially evenly spaced in a ringed rectangular arrangement proximate to the edges of the back wall 114. In some embodiments, a ringed arrangement of light sources 104 can surround the battery 110, as shown in FIG. 4. In alternate embodiments, a plurality of light sources 104 can be arranged in an array of evenly spaced rows and columns, as shown in FIG. 6. In still other embodiments, the mobile device case 100 can comprise a single light source 104 on the housing 102, or comprise a plurality of light sources 104 on the housing 102 that can be arranged in a pattern, be unevenly spaced, be arranged in offset rows, or be positioned in any other arrangement.

Each of the one or more light sources 104 can be configured to selectively emit light. In some embodiments, some or all of the light sources 104 can be LEDs (Light Emitting Diodes). By way of non-limiting examples, some or all of the one or more light sources 104 can be white LEDs that output white light, or can be red, green, and blue (RGB) LEDs that can produce light of a variety of colors. In other embodiments, some or all of the one or more light sources 104 can be xenon flash tubes or any other type of light source. Together, the light emitted by the one or more light sources 104 can be brighter than the light output by the mobile device's flash. By way of a non-limiting example, in some embodiments the light sources 104 can be configured to, in combination, emit light that is five to ten times brighter than the light produced by the mobile device's flash.

The light sources 104 can provide light at an illuminance of at least 1 lumen per square meter (lux), 2 lux, 3 lux, 4 lux, 5 lux, 6 lux, 7 lux, 8 lux, 9 lux, 10 lux, 50 lux, 100 lux, 500 lux, 1000 lux, 50,000 lux, 10,000 lux, or any other number of lux. The case 100 can include various numbers and/or configurations of light sources 104. The case 100 can include at least 1, 2, 3, 4, 5, 6, 7, 8, 9, 10, 20, 30, 40, 50, 60, 70, 80, 90, 100, 1000 light sources 104, or any other number of light sources 104. In some embodiments, the light sources 104 can be situated around a periphery of the case 100. In alternate embodiments, some or all of the light sources 104 can be clustered.

The light sources 104 can be configured to direct light away from the case 100 and a mobile device mounted by the case 100. The mobile device can include an electronic screen that is viewable by a user. The light sources 104 can be situated such that they direct light along a direction that is oriented away from the screen and a face of the user.

In some embodiments, all of a plurality of light sources 104 can produce light of the same color temperature. By way of a non-limiting example, in some embodiments each light source 104 can output cool white light at 5000 Kelvin. In other embodiments, one or more light sources 104 can produce light of different color temperatures than one or more other light sources 104. By way of a non-limiting example, in some embodiments one subset of light sources 104 can output warm light at 3000 Kelvin that mimics the light of an incandescent bulb, which can sometimes be more flattering to an indoor subject, while a different subset of light sources 104 can output cool light at 5000 Kelvin that mimics daylight, which sometimes can be more flattering to an outdoor subject.

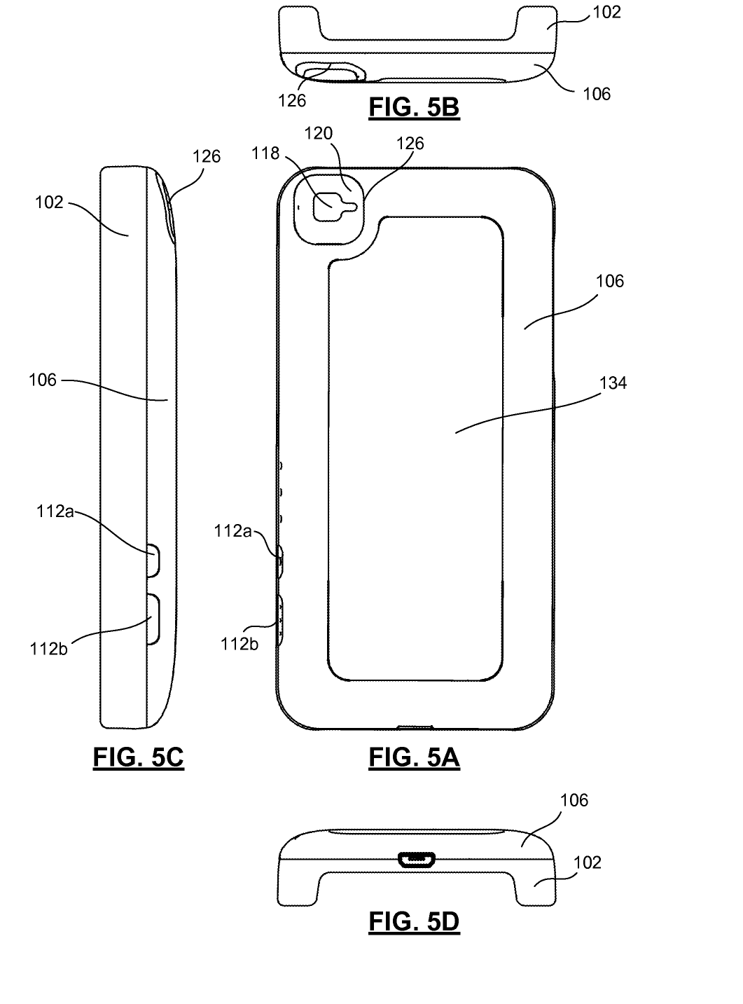

FIGS. 5A-5D depict back, top, side, and bottom views of the embodiment shown in FIG. 4 with a diffuser 106 attached over the light sources 104. The mobile device case 100 can comprise at least one diffuser 106. In some embodiments, the diffuser 106 can be coupled with the back wall 114 on top of one or more light sources 104, such that light emitted by the light sources 104 passes through the diffuser 106. By way of a non-limiting example, in some embodiments the diffuser 106 can be a shaped as a substantially rectangular ring around the side edges of the back wall 114, such that it surrounds the battery 110 and covers a ringed rectangular arrangement of light sources 104, as shown in FIG. 5A. In alternate embodiments, the mobile device case 100 can comprise a plurality of discrete diffusers 106, each positioned over and covering individual light source 104, as shown in FIG. 6. In still other embodiments, the diffusers 106 can cover a portion of the back of the housing 102 as shown in FIG. 7, or cover substantially the entire face of the back wall 114 as shown in FIG. 8. As shown in FIG. 8, the diffusers 106 can be shaped with or display a design or pattern, such as stripes, waves, or any other design.

In some embodiments, the diffuser 106 can have an aperture 126 that aligns with an aperture 118 in the back wall 114, such that the mobile device's camera sensor can have a line of sight through both apertures 118 and 126, or be otherwise shaped such that the diffuser 106 does not cover or obstruct the camera sensor's line of sight when the mobile device is retained by the mobile device case 100. By way of a non-limiting example, FIG. 2 depicts a diffuser 106 having an aperture 126 configured to surround the aperture 118 and aperture frame 120 of the housing 102. In some embodiments, the diffuser 106 can be permanently coupled with the back wall 114 or other components of the mobile device case 100. In other embodiments, the diffuser 106 can be selectively removable from the back wall 114 or other components of the mobile device case 100.

The diffuser 106 can comprise an at least partially translucent material that softens light that passes through it, such that the light that exits the diffuser 106 is softer than the light produced by the light sources 104. By way of a non-limiting example, in some embodiments the diffuser 106 can comprise a light diffusing polycarbonate compound. In some embodiments, the diffuser 106 can be made of a non-colored or substantially non-colored transparent or translucent material that does not substantially alter the color and/or color temperature of the light produced by the light sources 104 as the light passes through the diffuser 106.

In some situations, the diffuser 106 can permit about or at least about 5%, 10%, 15%, 20%, 30%, 40%, 50%, 60%, 70%, 80%, 90%, or any other percentage of light to pass through the diffuser 106. In some examples, the diffuser 106 does not permit all light to pass through the diffuser 106, but permits at most about 99%, 95%, 90%, 80%, 70%, 60%, 50%, 40%, 30%, 20%, 10%, 5%, or any other percentage of light to pass through the diffuser 106.

In alternate embodiments, the diffuser 106 can be made of a translucent material that alters the color and/or color temperature of the light produced by the light sources 104 as the light passes through the diffuser 106. By way of a non-limiting example, in some embodiments the diffuser 106 can comprise a colored gel, coating, glass, plastic, or film that can alter the color and/or color temperature of light as the light passes through the diffuser 106. In other embodiments, the diffuser 106 can be lenses of glass, plastic, or other material that can be polarized with electric signals to affect the light exiting the diffuser 106. In some embodiments, diffusers 106, colored gels, or lenses can be independently mechanically moved over and away from individual light sources 104, such that the color and/or color temperature of the light exiting the diffuser 106 can be selectively altered and controlled by a user with hardware controls 112. In some embodiments, individual colored diffusers, coatings, films, gels, or lenses can be present over individual light sources 104 underneath a larger non-colored diffuser 106 that covers all of the light sources 104 and individual colored diffusers, coatings, films, gels, or lenses. In other embodiments, a single diffuser 106 can have both colorizing and light diffusing qualities.

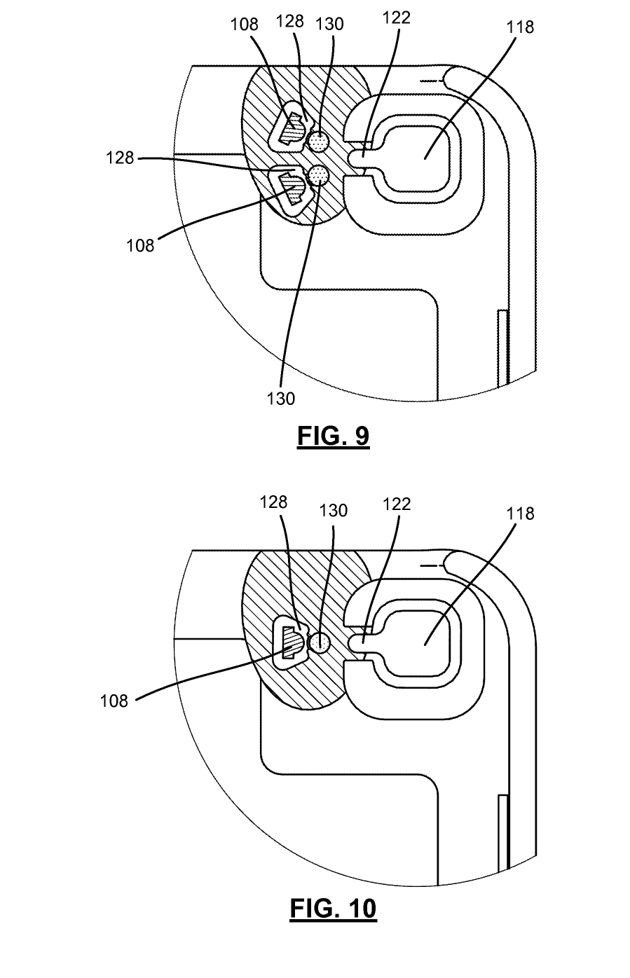

FIGS. 9 and 10 depict close up views of a partial cross section of a corner of embodiments of the mobile device case 100. The mobile device case 100 can comprise at least one flash detector 108 configured to detect the illumination produced by at least one flash of a mobile device. In some embodiments, the flash detector 108 can be a photodiode. In other embodiments, the flash detector 108 can be a phototransistor, bi-directional light emitting diode (LED), or any other type of light sensor or detector.

The flash detector 108 can be positioned on or within the mobile device case 100 at a location proximate to a flash of the mobile device when the mobile device is retained by the mobile device case 100. In some embodiments, the flash detector 108 can be housed in a light chamber 128 within the back wall 114 and/or PCB 124, as shown in the cross sections of FIGS. 9 and 10. The light chamber 128 can be at least partially open, such that light from the mobile device's flash can enter the light chamber 128 and be detected by the flash detector 108 inside the light chamber 128. In some embodiments, the opening to the light chamber 128 can be filled with a transparent or translucent lens 130. In alternate embodiments, the flash detector 108 can be coupled with the face of the back wall 114 or PCB 124.

The mobile device case 100 can turn on one or more of the light sources 104 when illumination from a mobile device's flash is detected by the flash detector 108, and turn off the light sources 104 when the illumination is no longer detected by the flash detector 108. By way of a non-limiting example, when the mobile device's flash illuminates during photography, the flash detector 108 can detect the flash's illumination and turn on at least some of the light sources 104 to replace the light produced by the mobile device's flash. In alternate embodiments, the mobile device case 100 can comprise a chip, processor, or other electronic component configured to receive a signal from the mobile device through a wired or wireless connection instructing the mobile device case 100 to illuminate its light sources 104 in lieu of the mobile device's flash.

In some embodiments, the mobile device case 100 can comprise a plurality of flash detectors 108, as shown in FIG. 9. While many mobile devices have flashes with a single light source, other mobile devices have flashes comprising two or more distinct light sources that each output light of a different color temperature, or have multiple flashes that each output light of a different color temperature. A mobile device case 100 configured to operate with a particular mobile device that is configured to emit light of different color temperatures from different flashes or light sources can comprise a plurality of flash detectors 108, with each flash detector 108 aligned with an individual flash or light source of the mobile device, such that the firing of each individual flash or light source by the mobile device can be detected independently by individual flash detectors 108. In these embodiments, the detection of individual or combined flashes of different color temperatures by separate flash detectors 108 can be used by the mobile device case 100 to determine what color temperature light should be output by the light sources 104 and/or diffuser 106. Some embodiments of the mobile device case 100 that comprise a plurality of flash detectors 108 can also be used with mobile devices that have a single flash with a single light source, in that each individual flash detector 108 can work together and/or independently to detect the light and/or light temperature output by the single flash. In other embodiments, a single flash detector 108 can be present within the mobile device case 100, as shown in FIG. 10. By way of a non-limiting example, an embodiment of the mobile device case 100 configured to operate with a mobile device that has a single flash can comprise a single flash detector 108 aligned with the mobile device's single flash.

The mobile device case 100 can have opaque components proximate to and/or surrounding the flash detector 108, such that the light produced by the mobile device's flash does not pass through the mobile device case 100. By way of a non-limiting example, the back wall 114 can be opaque and can cover the flash detector 108 and flash of the mobile device, such that light output by the flash can pass into the flash detector 108 but be blocked from passing through the back wall 114 or walls of the light chamber 128 to the exterior of the mobile device case 100. The back wall 114 can block at least 50%, 60%, 70%, 80%, 90%, 95%, 99%, 99.9%, or any other percentage of light from the flash of the mobile device from passing through the back wall 114. For example, the back wall 114 can be formed of a polymeric material that is coated with a dark or substantially dark coating (e.g., black coating). When the flash detector 108 detects that the mobile device's flash has been illuminated, the mobile device case 100 can replace the blocked light from the mobile device's flash with light from its own light sources 104. By blocking the light output from the mobile device's flash and substituting a flash from its own light sources 104, the mobile device case 100 can control the brightness and color temperature of the light that reaches the photography scene from one or more of its light sources 104 and diffuser 106 without needing to account for the light also being produced by the mobile device's own flash.

The flash of many mobile devices illuminates twice during photography, with a pre-flash before image capture and main flash during image capture. For example, the mobile device's flash can illuminate relatively quickly with a pre-flash at a low brightness setting to allow the mobile device's components to focus the camera, set the exposure and/or make other photographic measurements, then illuminate again with a main flash for a relatively longer period at a higher brightness during which the final image is captured. The mobile device can know the expected ratio of the brightness of the pre-flash and main flash, and use that expected ratio of brightness levels to set the exposure during image capture.

In some embodiments, the flash detectors 108 of the mobile device case 100 can detect both the pre-flash and main flash from the mobile device's flash, and the detection can trigger one or more of the light sources 104 to illuminate, thereby substituting the mobile device's pre-flash and main flash at higher brightness levels and/or different color temperatures. Although the actual brightness levels of the substitute pre-flash and main flash produced by the light sources 104 of the mobile device case 100 can be higher than the flashes produced by the mobile device's flash, the mobile device case 100 can substantially replicate the ratio of brightness levels between the pre-flash and main flash that the mobile device expects, such that the mobile device can continue to properly set the exposure level despite the increased brightness level. In some embodiments, the ratio of brightness levels can be preset in the mobile device case 100 based on the particular model of mobile device. In other embodiments, the mobile device case 100 can learn the expected ratio of brightness levels by detecting and comparing the brightness of the pre-flash and main flash with the flash detector 108. In still other embodiments, a user can manually change or set the ratio of brightness levels of the mobile device case's substitute pre-flash and main flash through hardware controls 112.

In some embodiments, the first illumination detected by the flash detector 108 can be assumed by the mobile device case 100 to be a pre-flash for a preset amount of time, during which the light sources 104 can produce a substitute pre-flash at a desired brightness level. However, if the flash detector 108 continues to detect the illumination for longer than the preset amount of time, the mobile device case 100 can determine that the illumination is not a pre-flash but is instead continuous illumination, for example to provide light for video capture or a flashlight application, and can instruct the light sources 104 to change the brightness level of the substitute flash to a level more appropriate for continuous illumination. By way of a non-limiting example, when the flash detector 108 continues to detect illumination from the mobile device's flash for longer than the preset amount of time, the light sources 104 can decrease the brightness level of the light they output from the level of a pre-flash to a lower level that uses less power and/or produces less heat. In other embodiments, the brightness level can remain constant even when continuous illumination is detected. In some embodiments, when the flash detector 108 continues to detect illumination from the mobile device's flash for longer than the preset amount of time, the mobile device case 100 can provide a user with the option to manually change the brightness and/or color temperature of the light output by the light sources 104 using hardware controls 112 while the continuous illumination is ongoing.

The mobile device case 100 can comprise at least one battery 110. The batteries 110 can be electrically coupled with the light sources 104, flash detectors 108, and/or other electrical components of the mobile device case 100. By way of a non-limiting example, the batteries 110 can provide power to the light sources 104 and/or flash detectors 108. At least one battery 110 can be configured to quickly provide power to the light sources 104 upon detection of illumination from the mobile device's flash by the flash detector 108, such that the light sources 104 turn on and illuminate the surrounding area before and/or during image capture. By way of a non-limiting example, in some embodiments the batteries 110 can provide up to 20 Amps of burst power to the light sources 104. In some embodiments, the battery 110 can be a high discharge rate lithium polymer battery. In some embodiments, the battery 110 can be rechargeable. The battery 110 can be connected to a power source through a port 132 with a micro-USB cable, USB cable, or any type of power cable or connection, such that the battery 110 charges when connected to a power source or outlet.

In some embodiments, a single battery 110 can be present to power the other electrical components of the mobile device case 100. In other embodiments, the mobile device case 100 can comprise a plurality of batteries 110 configured to collectively or independently power electrical components of the mobile device. By way of a non-limiting example, in some embodiments one battery 110 can provide power to a subset of the light sources 104 that produces light of a cool color temperature, while another battery 110 can provide power to a different subset of the light sources 104 that produces light of a warmer color temperature.

In some embodiments, the one or more batteries 110 can be located on or within the back wall 114. In some embodiments, the mobile device case 100 can comprise one or more battery covers 134, such that the battery covers 134 can be selectively removed by a user to replace the batteries 110. The battery covers 134 can be on the back of the mobile device case 100, on the front of the mobile device case 100 within the back wall 114, or at any other location. In other embodiments, the mobile device case 100 can comprise non-removable batteries 110. In alternate embodiments, the batteries 110 can be absent, and the mobile device case 100 can draw power from an electrical connection with the mobile device inserted into the mobile device case 100.

As discussed above, in some embodiments the batteries 110 can be located at the center of the back wall 114, surrounded by a ringed arrangement of light sources and/or ring-shaped diffuser 106. By way of a non-limiting example, FIGS. 1, 2, and 5A-5D depict embodiments of the mobile device case 100 in which the diffuser 106 is shaped as a substantially rectangular ring and has a central aperture, with the batteries 110 positioned within the central aperture of the diffuser 106, such that the top of the batteries 110 or the battery cover 134 can be substantially flush with the top of the diffuser 106. In alternate embodiments, the diffuser 106 can extend across the entire face of the back wall 114 and cover the battery 110 and light sources 104, as shown in FIG. 8.

The mobile device case 100 can comprise one or more hardware controls 112. The hardware controls 112 can be buttons, dials, sliders, switches, and/or any other type of control mechanism. The hardware controls 112 can be used to turn on the flash detector 108 and/or one or more light sources 104, select or modify the color and/or color temperature of the light produced by the light sources 104, adjust the brightness of the light produced by the light sources 104, and/or control any other function of the mobile device case 100.

As discussed above, in some embodiments different subsets of the light sources 104 can produce light of different colors and/or color temperatures. In some of these embodiments, a user can use the hardware controls 112 to select which subset of light sources 104 to use depending on the desired color and/or color temperature, or mix the number of light sources 104 active in each subset to vary the color and/or color temperature. In other embodiments, the light sources 104 can be RGB LEDs, and users can use the hardware controls 112 to mix the levels of red, green, and/or blue light output by the plurality light sources 104 to produce any desired color of light. In still other embodiments, hardware controls 112 can be used to select and/or position colored diffusers 106 over one or more light sources 104 to adjust the color and/or color temperature of the light produced by the light sources 104.

As shown in FIG. 1, in some embodiments the mobile device case 100 can comprise two hardware controls 112: button 112a and button 112b. In some embodiments, button 112a can control the brightness of the light produced by the light sources 104, and button 112b can control the color temperature of the light produced by the light sources 104. In other embodiments, button 112a can be an on/off button, and button 112b can control the color and/or brightness of the light produced by the light sources 104. In some embodiments, one or more hardware controls 112 can be pressed multiple times to cycle through levels of brightness and color temperature.

In some embodiments, the mobile device case 100 can further comprise one or more indicators 136, as shown in FIG. 1. In some embodiments, the indicators 136 can be LEDs, such as RGB LEDs that can output light of substantially any color. In some embodiments, the indicators 136 can be configured to output light through the diffuser 106 or through openings in the diffuser 106 and/or housing 102. The indicators 136 can be configured to indicate the selected level of brightness and/or color temperature. By way of a non-limiting example, in some embodiments the mobile device case 100 can have three pre-set levels of brightness and color temperature, and a single indicator 136 can illuminate to indicate the lowest level of brightness, two indicators 136 can illuminate to indicate the middle level of brightness, and three indicators 136 can illuminate to indicate the highest level of brightness, while the color output by the indicators 136 can range between a blue color to indicate a cooler color temperature to an orange color to indicate a warmer color temperature.

In some embodiments, hardware controls 112 can switch the mobile device case 100 from a basic mode with a lower number of preset levels of brightness and/or color temperature to an advanced mode with a higher number of possible levels of brightness and/or color temperature. By way of a non-limiting example, in some embodiments buttons 112a and buttons 112b can be pressed simultaneously to move from a basic mode with three preset levels of brightness and/or color temperature to an advanced mode with six preset levels of brightness and/or color temperature.

In alternate embodiments, the hardware controls 112 that control the brightness and/or color temperature of the light produced by the light sources 104 can be sliders or dials that moves between a range of positions. In some embodiments, the positions can be marked by indicators such as dashes, numbers, or other indicia printed, inscribed, or otherwise displayed on the mobile device case 100.

In alternate embodiments, the mobile device case 100 can comprise one or more auxiliary sensors configured to determine the characteristics of the ambient light in the mobile device case's immediate environment. The auxiliary sensors can be light sensors configured to detect the brightness of the surrounding environment, color temperature sensors configured to detect the color temperature of the surrounding environment, CMOS image sensors, and/or any other type of sensor. The mobile device case 100 can use the information detected by one or more auxiliary sensors to automatically modify the brightness, color, and/or color temperature of the light produced by the light sources 104 to match the light characteristics of the environment.

In use, a user can cause the mobile device's flash to illuminate. By way of a non-limiting example, the user can take a picture with the mobile devices' camera, and the mobile device's flash can illuminate as part of the photography process. As other non-limiting examples, the user can activate illumination of the mobile device's flash during video capture, use of an application such as a flashlight application, or any other use of the mobile device's flash. When the mobile device's flash is illuminated, one or more flash detectors 108 can detect the light from the mobile device's flash. The light produced by the mobile device's flash can be blocked from view outside the mobile device case 100 by the mobile device case's opaque components. The flash detectors 108 can activate one or more light sources 104 in response to the detection of light from the mobile device's flash, as a replacement for the mobile device's flash. One or more light sources 104 can turn on and output light for the length of time that the flash detector 108 detects light from the mobile device's flash. By way of non-limiting examples, the light sources 104 can be activated as a substitute pre-flash or main flash to assist in lighting a scene for a photograph, or for a longer time period as a torch for continuous illumination of a scene during video capture. The one or more light sources 104 can be turned on for the same period of time as the flash detector 108 detects illumination from the mobile device's flash. As discussed above, a user can use one or more hardware controls 112 to adjust the brightness, color, and/or color temperature of the substitute illumination produced by the mobile device case 100. In some embodiments, the flash detectors 108 can detect the color temperature of the illumination from the mobile device's flash and the mobile device case 100 can use that detected color temperature to adjust the color temperature of the light produced by its own light sources 104. When the flash detector 108 determines that the mobile device's flash is no longer illuminated, the mobile device case 100 can deactivate the light sources 104.

As discussed above, in some embodiments different power sources or batteries 110 can be used to power different subsets of the light sources 104 that each output light at different color temperatures, with the independent subsets being used at different brightness levels to achieve output of light at a desired color temperature. By way of a non-limiting example, a medium color temperature can be mixed by setting the cooler subset of light sources 104 to output light at 50% brightness and the warmer subset of light sources 104 can output light at 100% brightness, such that the relatively smaller level of cooler light cools the stronger warmer light.

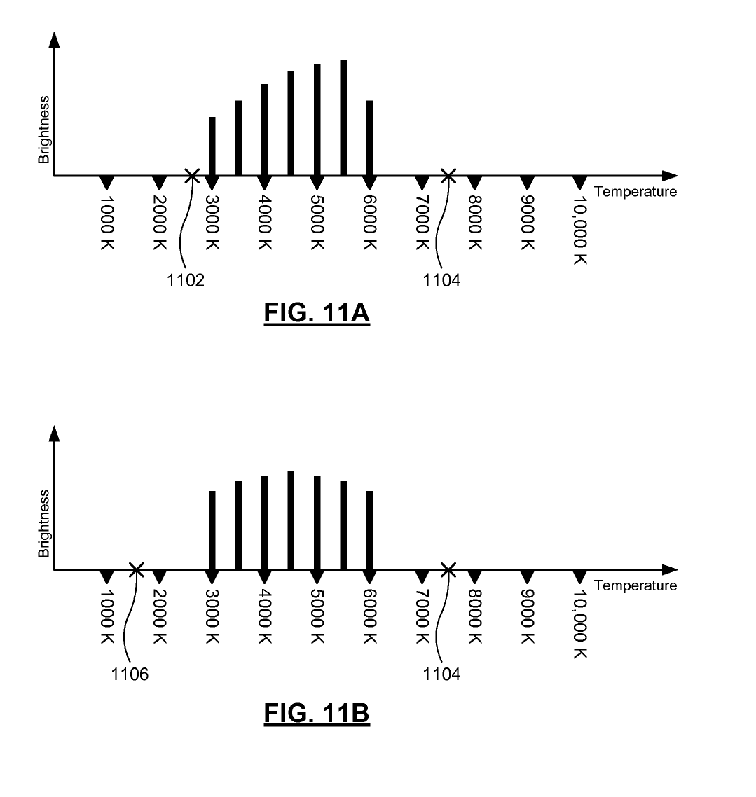

However, in some situations white LEDs with a high color rendering index suitable for photography can be impractical and/or commercially unavailable at color temperatures warmer than around 2500 Kelvin or cooler than around 8000 Kelvin. FIG. 11A depicts the relative maximum brightness levels of possible color temperature mixes between 3000 Kelvin and 6000 Kelvin in embodiments in which 2700 Kelvin LEDs are used as the warmest subset of light sources 104 (shown at position 1102) and 7500 Kelvin LEDs are used as the coolest subset of light sources (shown at position 1104). As can be seen from FIG. 11A, maximum brightness can be lost at the ends of the color temperature spectrum, and/or changes in color temperature can result in inconsistent maximum brightness level changes, because both subsets of lights sources 104 cannot be used at full brightness for many potential color temperature mixes.

However, by using diffusers 106 or other gels, coatings, films, or glass or plastic lenses discussed above that can alter the color temperature of the light passing through them from a light source 104, the variation of maximum brightness can be smoothed into a more consistent curve through the range of possible color temperature mixes. Diffusers 106, gels, coatings, films, or lenses can be used on either or both subsets of light sources 104 to warm and/or cool the light output by the subsets of light sources 104. FIG. 11B depicts the relative maximum brightness levels of possible color temperature mixes in embodiments in which the light output at the warm end of the spectrum by the 2700 Kelvin LEDs used in FIG. 11A is further warmed to about 1500 Kelvin (shown at position 1106) using a diffuser 106 or other material, and the 7500 Kelvin LEDs at the cool end of the spectrum have the color temperature of their light unaltered by a diffuser 106 or other material. As can be seen from a comparison of FIGS. 11A and 11B, the use of a diffuser 106 or other material to further warm the color temperature of the light output by the warm subset of light sources 104 can flatten out the curve of maximum brightness levels and reduce brightness variation between different possible color temperature mixes of the two subsets of light sources 104. This can allow the batteries 110 or other power supplies to operate at higher capacities at more locations on the color temperature spectrum.

Warming and/or cooling diffusers 106 or other materials can be used in some embodiments of the mobile device case 100 to flatten the curve of maximum brightness levels along the spectrum of possible color temperature mixes when the mobile device case 100 adjusts the color temperature and brightness of its substitute illumination. Similarly, warming and/or cooling diffusers 106 or other materials can be used to flatten brightness curves along the color temperature spectrum by other types of hardware that is programmed or otherwise configured to mix light by combining light from distinct light sources 104 at different color temperatures, such as photography flashes or lamps, LED displays, or other types of light sources or hardware. The hardware can permit a user to customize the color temperature of the light output by the light sources 104.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

1. A mobile device case, comprising:
a housing configured to couple with a mobile electronic device having a camera sensor and flash;
at least one flash detector coupled with said housing configured to detect illumination from the mobile electronic device's flash; and
one or more light sources coupled with said housing and said at least one flash detector, wherein at least a portion of said housing is opaque, such that illumination from the mobile electronic device's flash is blocked from passing through said housing, and wherein said one or more light sources are activated in response to said at least one flash detector detecting illumination from the mobile electronic device's flash, such that at least a portion of the blocked illumination from the mobile electronic device's flash is replaced by illumination from said one or more light sources.

2. The mobile device case of claim 1, wherein said one or more light sources are positioned in a ringed arrangement around or in proximity to the edges of a back portion of said housing.

3. The mobile device case of claim 2, further comprising a battery coupled with said housing.

4. The mobile device case of claim 3, wherein said battery is at or in proximity to a center of the ringed arrangement of said one or more light sources.

5. The mobile device case of claim 3, further comprising a ring-shaped diffuser coupled with said housing above the ring-shaped arrangement of said one or more light sources and surrounding said battery, wherein said ring-shaped diffuser comprises translucent material configured to soften light passing through said diffuser.

6. The mobile device case of claim 1, further comprising:
a diffuser coupled with said housing above said one or more light sources, said diffuser comprising translucent material configured to soften light passing through said diffuser.

7. (canceled)

8. The mobile device case of claim 1, wherein said one or more light sources comprises a first subset of light sources and a second subset of light sources, said first subset of light sources being configured to produce cool light and said second subset of light sources being configured to produce warm light.

9. The mobile device case of claim 8, wherein said one or more light sources mixes the color temperature of the light output by said one or more light sources by adjusting the brightness levels of the cool light output by said first subset of light sources and adjusting the brightness levels of the warm light output by said second subset of light sources.

10. (canceled)

11. The mobile device case of claim 1, further comprising one or more brightness level selection hardware controls configured to allow a user to customize the brightness level of the light output by said one or more light sources.

12. The mobile device case of claim 1, wherein said at least one flash detector is programmed to (i) detect a pre-flash and a main flash from the mobile device's flash, and (ii) output replacement illumination by said one or more light sources during the detection of the pre-flash and main flash, which replacement illumination is brighter than the pre-flash and main flash at substantially the same ratio of brightness levels of the mobile device.

13. The mobile device of claim 1, wherein said at least one flash detector comprises a first flash detector configured to detect illumination of a first color temperature and a second flash detector configured to detect illumination of a second color temperature.

14. A method of replacing a camera flash of a mobile electronic device, comprising:
providing a mobile device case mounted on a mobile electronic device that comprises a camera flash, wherein said mobile device case comprises (i) a flash detector that is positioned to detect flash illumination from said camera flash and (ii) one or more light sources that direct light along a direction away from said mobile device case;
detecting flash illumination from said camera flash using said flash detector;
blocking at least a portion of said flash illumination such that said at least the portion of the flash illumination does not pass through said mobile device case to reach a scene being photographed; and
activating said one or more light sources in response to the detection of said flash illumination to provide replacement illumination to the scene being photographed.

15. The method of claim 14, wherein said replacement illumination is brighter than said flash illumination.

16. The method of claim 14, further comprising changing the brightness of said replacement illumination in response to user input.

17. The method of claim 14, wherein said replacement illumination has a different color temperature than said flash illumination.

18. The method of claim 14, further comprising changing the color temperature of said replacement illumination in response to user input.

19. A method of mixing color temperatures of light, comprising:
providing at least one first light source configured to output light of a first color temperature;
providing at least one second light source configured to output light of a second color temperature;
placing a warming material configured to warm the color temperature of light passing through said warming material over each of said at least one first light source, such that said warming material warms the light output by said at least one first light source from said first color temperature to a third color temperature;
adjusting the brightness of the light output by said at least one first light source and said at least one second light source to output a combined mixed light of a predetermined color temperature.

20. (canceled)

21. (canceled)
